(19) United States
(12) Patent Application Publication
(10) Pub. No.: US 2019/0114667 A1
(43) Pub. Date: Apr. 18, 2019

(54) BROADCAST ADVERTISEMENT TARGETING BASED ON INTERNET HISTORY

(71) Applicant: ACTV8, Inc., Beverly Hills, CA (US)

(72) Inventor: Brian Shuster, Beverly Hills, CA (US)

(21) Appl. No.: 16/164,645

(22) Filed: Oct. 18, 2018

Related U.S. Application Data
(60) Provisional application No. 62/574,171, filed on Oct. 18, 2017.

(51) Int. Cl. G06Q 30/02; H04N 21/258; H04N 21/45; H04L 29/08

(52) U.S. Cl. CPC G06Q 30/0255; G06Q 30/0269; H04L 67/22; H04N 21/4532; H04N 21/25883

(57) ABSTRACT

A system and method are described to enable advertisers to deliver dynamic targeted commercials during standard televised broadcasts based on a viewer's interest using the viewer's Internet browsing/shopping/searching history. The viewer's Internet browsing/shopping/searching history is made available through devices the user uses such as a mobile device, desktop, laptop, or other Internet enabled device in the home or office. The browsing data is collected and uploaded to an ad server, which data is aggregated, analyzed, and associated with a relevant promotion. From here the data is fed back to a cable or satellite provider ad server to deliver a targeted commercial ad to the user during an allocated spot within a commercial break of a program being watched on TV.

### BACKGROUND OF THE INVENTION

The invention relates to how television commercials are provided to consumers. In the prior art, a user, while viewing a broadcasted television program is interrupted by commercial breaks during which a product or service is advertised which may or may not have any relevance to the viewer. The user, as shown in FIG. 1 may also be using a mobile device or laptop 11 to browse the Internet at the same time. Although due to existing technology, the user may see ads which relate to the user's browsing history on the mobile device or laptop, these likely or other relevant ads have no way of being directed to the television 13 on which the broadcasted television program is displayed along with its commercial interruptions. The ads which are directed to the user originate from provider ad server 17 which sends ads which may be of no interest to the viewer to be shown on television 13. In the prior art, provider ad server 17 contains commercials prepared by content publishers. These ads are sent to content scheduler/distributor 19 which operates to send ads to television 13 based on no user specific information other than perhaps the particular program being watched at that time. This disconnect of the two technologies is shown in FIG. 1.

### SUMMARY OF THE INVENTION

A system and method are described to enable advertisers to deliver dynamic targeted commercials during standard televised broadcasts based on a viewer's interest using the viewer's Internet browsing/shopping/searching history.

The viewer's Internet browsing/shopping/searching history is made available through devices the user uses such as a mobile device, desktop, laptop, or other Internet enabled device in the home or office.

For example, assume a user is browsing the Internet for a new phone, TV, dress, or other product or service on a laptop or mobile device while watching TV. The browsing data is collected and uploaded to an ad server, which data is aggregated, analyzed, and associated with a relevant promotion. From here the data is fed back to a cable or satellite provider ad server to deliver a targeted commercial ad to the user during an allocated spot within a commercial break of a program being watched on TV. In this manner, instead of seeing a random ad, an ad relevant to a recent Internet search is shown. The collected browsing data includes cookies, browser history, products of interest based on cookies, location information, software profile, hardware profile, and connection type such as public and local IP addresses.

### BRIEF DESCRIPTION OF THE DRAWINGS

FIG. 1 is a block diagram showing existing user computing devices and television advertising components with no connection between the two.

FIG. 2 is a block diagram showing how the invented components connect the two prior art technologies.

FIG. 3 is a block diagram showing how existing technologies deliver targeted ads to user computing devices based on browsing history by those devices.

### DESCRIPTION OF THE INVENTION

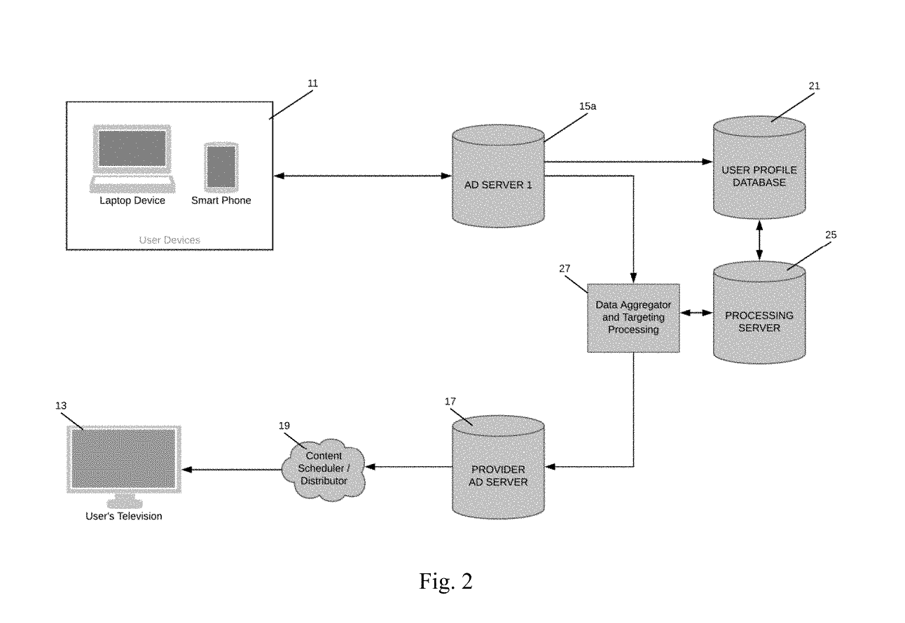

The system shown in FIG. 2 allows TV viewers, i.e., users to receive more relevant commercials and advertising during their TV viewing experience. Users frequently use mobile devices such as phones, tablets and laptops 11 while watching TV 13. User are browsing for products, connecting with family and friends, and looking for solutions, frequently while watching TV. By utilizing the user device 11 (laptop, phone, or tablet) and tapping into their browsing habits, the invention creates a better experience for the user by knowing that they are interested in a particular product or service based on their browsing experience so that relevant ads can be shown while watching TV.

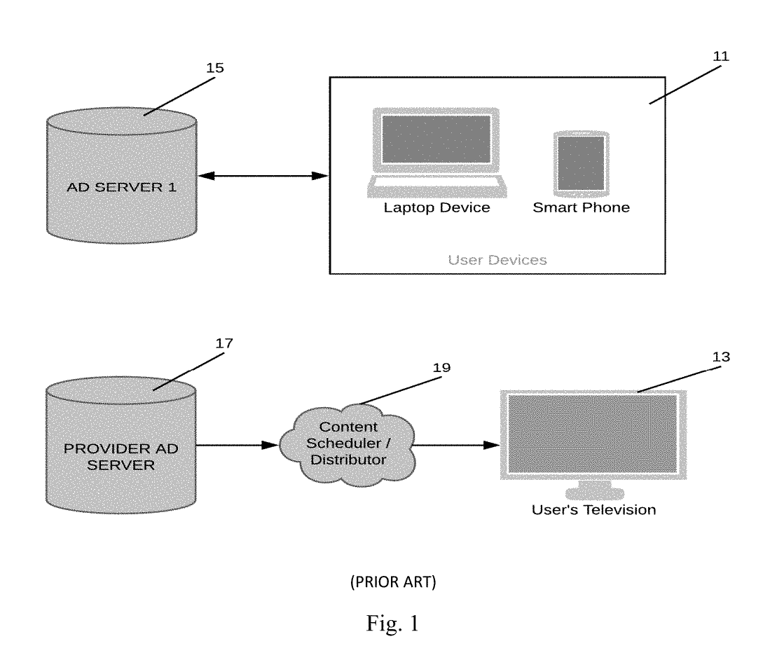

Once a user's profile has been acquired by ad server 15a in a manner known in the art, the profile is moved to user profile database 21 which operates to match available commercial content or offers to that user. The user profile database used by the invention is the same user profile database built by an ad server 15a based on a user's browsing history. Ad server 15a shown in FIG. 2 differs from ad server 15 shown in FIG. 1 as follows. Although ad servers 15 and 15a are functional equivalents, according to the invention, server 15a also communicates with data aggregator and targeted processing 27 so that data from server 15a is used by data aggregator and targeted processing 27 to determine what to deliver based on user specific information from user profile database 21 to deliver to provider ad server 17.

A typical user profile has the following information:

### 1) Unique Identifying Information

External IP address and example such as 43.177.188.201
Local IP address such as 192.168.1.110
Device fingerprint such as device.id 3514

### 2) Browsing History

### Example of History Record

| Website | Address |
|---|---|
| Mobii \| Terms | https://mobiimedia.com/terms |
| Mobii \| Terms | https://mobiiemedia.com/privacy |
| Mobii \| Terms | https://mobiimedia.com/faq |
| Mobii - Find Offers | https://itunes.apple.com/us/app/mobii-media- |
| from TV on the App | wallet/id980850266?mt=8 |
| Store | |
| Mobii App with Daily | http://mobiimedia.com |
| Scratchers | |
| Home \| actv8me | https://www.actv8me.com |

In this manner, if a user's browsing habits show recent activity for a new phone purchase, it would be in the interest of both the user and broadcaster to show advertising that is relevant to that user. The processing as disclosed herein will target the user with ads relevant to one who is looking for, in this example, a new phone. This information about the user is sent to a provider ad server 17 which operates to match the commercial recommendation for the user in a manner similar to existing systems where relevant ads are sent to a user's phone, laptop, etc. based on the user's browsing history. Ad Server 17 sends specific ads to a specific television 13 for a specific viewer. Data aggregator and targeting processing 27 sends the information about the user as explained below.

Although provider ad server 17 is existing technology, it is adapted to accept the recommendation from data aggregator and targeting processing 27 and then present the ad to that specific user via content scheduler/distributor 19. From there, the ad is pushed to the user's TV 13 and the user sees the relevant advertisement instead of a generic advertisement which would otherwise be shown.

### User Data Aggregation and Transmission to Ad Server:

### User Data Aggregation:

The first step of delivering targeted ads, i.e., commercials to any user is to build a profile for the specific user using ad server 15a and existing technology. As noted above, this profile contains unique identifiers (created from cookies, IP information, device fingerprint) for that specific user as well as past/current interests that allow advertisers to directly target that user with a specific promotion. Past and current interests are obtained via browsing data that is collected on a user's device.

User browsing data that is recorded during standard web sessions is used to build a consumer interest profile for each unique user. As this data is collected on the user's device and transmitted to ad server 15a from a service such as Google Marketing, the user's product interests and interaction history can be analyzed and used for offer targeting. The ad server's software is able to identify the browsing data from a user's profile and match it with currently available promotions.

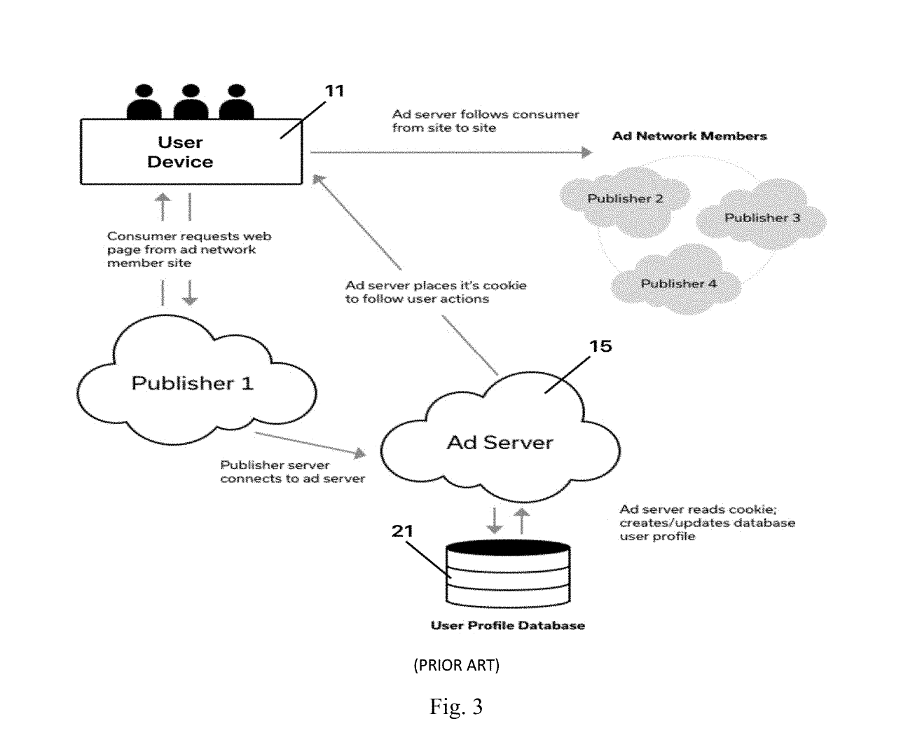

Referring now to FIG. 3 which illustrates existing systems, content publisher platforms Publisher 1, Publisher 2, Publisher 3 and Publisher 4 are websites run by entities who are offering information or products or services from their website. These are websites that a user visits while browsing the Internet while searching for information or a product or service. The ad server 15a and content publisher platforms operate to store all user historical/cookie data recorded during standard web sessions to build a consumer interest profile for each unique user. For example, an online publisher can set an ad server's cookie to tell them what sections of their sites the user is browsing. The ad server 15a will then build a user profile based on that information. This information is used to identify the types of offers the user may like to be shown. The user is identified and associated with the IP address and device IDs of the user's connected devices obtained from the user profile stored in user profile database 21. For example, if the user is on a news website and the user visits the sports pages, this indicates that the user is likely more interested in offers for game tickets rather than makeup. This information belongs to the content publisher only and the ad server collects it on behalf of the publisher using cookies.

Additionally, an ad server 15a may combine data across multiple publisher's web sessions to augment the user profile via use of cookies and IP addresses. The information could also include location information based on the IP address.

### Data Sent to Ad Server:

The next step is delivering the collected data from the publisher websites to the ad server 15a for association with current active promotions/analysis of the delivered cookie data from the user profile. The user's profile is pulled from the user profile database 21 to provide, cookies, browsing history, and date/time stamp of browsing interactions. The ad server 15a must be able to accept the new data and store it for use after processing through processing servers 25 which are part of data aggregator and targeting processor 27 unique to the invention. Once this process has completed by ad server 15a, the relevant information (user browsing data) will be sent to processing server 25 for identification of promotions related to the user's browsing history and interests. Server 15a sends data to processing server 25 and user profile database 21.

Processing server 25 operates like the existing Google Marketing Platform that delivers ads to a user device while using the browser. The cable or satellite provider ad server 17 delivers the ads to the television network.

As this data is collected by processing server 25 based on the user's interaction with web sites (across browsers, mobile devices), it is transmitted to data aggregator and targeting processing 27 where the user's product interests and interaction history can be analyzed and used for offer targeting. Data aggregator and targeting processing 27 receives ad server 15a data and looks to see if the user already exists in user profile database 21. If the user exists, the information from the users' interaction with web sites is added to the user profile for targeting. If the user does not exist, a new user profile is created and data aggregator and targeting processing 27 starts building a profile for that user based on the provided information.

Typically, an ad server 15a can collect information such as the following:
time: 13/Oct/2017 11:02:33
ad_placement_id: 016
ad_id: 1321
userid: 0000002340000001
internal client_ip: 192.168.10.240
external client_ip: 48.271.15.129
referral_url: “https://www.yahoo.com/?err=404&err_url=https%3a%2f%2fwww.yahoo.com%2f%2522”
interest: “sports” (where does this come from???)

This provides the ad server 15a the time and date the user saw a page. It also shows userid, which is the unique ID number the cookie has given to the user browser, ad_id which is the unique ID of the ad and referral_url which is the page the user was on when he or she saw the ad. Because it records the user external IP address, the ad server can also make a good guess of the country and town/city of the user.

### Data Transmission to Processing Server 25

Once the data leaves the ad server 15a for delivery directly to processing server 25, the next step will be identification of the user. For this, processing server 25 pulls external IP and profile data for the user from user profile database 21 and compares it against a list of existing user data from stored by data aggregator and targeting processing 27. If the user already exists in the database used by processing server 25, then the user's profile data stored on that database used by processing server 25 will be appended with the new data from ad server 15a which expands upon the user's current interest set. If the user is new, that is not previously known to processing server 25 then a new generic profile containing all browsing data for the user from ad server 15a will be generated to track future user interaction/interest data.

Participating publishers 1, 2 and 3 shown in FIG. 3 allow ad server 15a to share the data collected on its behalf to processing server 25. Although the systems shown in FIG. 3 exist, the participating publishers make necessary modifications to allow access by processing server 25. The specific modifications necessary are not important to an understanding of the invention, and are well within the skills of a person with ordinary skill in the art. As a user goes from one website to another, participating publishers allow third parties to collect the cookie and other information from one publisher to another for their mutual benefit.

This could happen near real-time over the Internet via web services or via asynchronous mechanisms such as file exchanges or bulk transfers.

The data format will vary from one ad server 15a to the next and one publisher to the next, but can include all the information specified above, i.e., client_ip, referral url, interest, time, ad_id, ad_placement_id, userid. In addition, the information may be provided as aggregated content for a client_ip. The information is likely to be tag, value pair, usually captured using a markup language like XML, JSON, etc.

Once the server connections are properly authenticated and authorized, data transmission can be initiated. This authentication happens between existing server to server API keys and credentials. Ad server 15a provides keys for user profile database 21 and data aggregator 27 in a manner well known in the art.

Example of data transmitted as a file or data-stream could look as follows:

```
<Clients>
          <Client>
                <ClientIP>32.3.120.440</ClientIP>
                <ClientTime>
                    13/Oct/2017 11:02:33
                <</ClientTime>
                <<ClientAdPlacementID>016</ClientAdPlacementID>
                <<ClientID>1321</ClientID>
                <<ClientURL>
                    https://www.yahoo.com/?err=404&err_url=
                    https%3a%2f%2fwww.yahoo.com%2f%2522
                </ClientURL>
                <ClientInterest>sports</ClientInterest>
          </Client>
          <Client>
                <CientIP>32.3.120.440</ClientIP>
                <ClientTime>
                    13/Oct/2017 11:18:33
                </ClientTime>
                <ClientAdPlacementID>023</ClientAdPlacementID>
                <ClientID>1321</ClientID>
                <ClientURL>
                    https://www.bestbuy.com/?ref=30&loc=KW-
                    4327&ksid=ce93d96f-4207-482b-8ec9-
                    f9d3d52910a4&ksprof_id=3&ksaffcode=202195&
                    ksdevice=c&gclid=EAlalQobChMljc3cmZv21gIV
                    Dp7ACh3k1wJOEAAYASAAEgKoyfD_BwE
                </ClientURL>
                <ClientInterest>electronics</ClientInterest>
          </Client>
</Clients>
```

Once the information is received and processed by processing server 25, a processing server user profile segmenting service component of processing server compares the new data against the processing server's existing data and match ip address and user data to augment the user profiles and create/update user segments.

Some examples of user segments could be male, baby boomer, football lover, etc.

### Processing Server Data Processing and Targeting

Once the processing server 25 has received all relevant information from the user up to this point (Cookie Data, User Profile Data, IP Data, Date/Time), the processing server 25 begins the targeting phase of the process. This involves initiation of an automated review of the user's cookie/product interest data by the software of the processing server, associated promotion checks within the processing server and against the data sent by the provider's ad server 17, and transmission of the user profile data and interest data to the provider's ad server 17 for promotion delivery. Provider Ad Server 17 will accept the recommendation that is output from data aggregator and targeting processing 27 as explained above.

Once a relevant ad is identified, the user identification data and the ad to be displayed will be then transmitted to the provider's ad server 17 environment which sends a selected ad to content scheduler/distributor 19 which sends the ad to the television 13 at the appropriate time in a manner well known in the art.

The processing server 25 maintains a database of ads with meta-data from providers. Provider ad server 17 provides processing data aggregator and targeting processing 27 which updates processing server 25 with the database of ads for recommendation.

Typically, an ad will include Ad Title, Ad descriptions, Ad images, Ad videos. An Ad metadata may include campaign start and end dates, user segments, appropriate time of the day to display, frequency and sequence to be displayed, rotation rules across other ads.

Processing server 25 user data is grouped in segments based on enhanced information received from ad server 15a. Each user segment is than associated with a campaign that is suitable for that segment. Based on the metadata received for a user, processing server 25 identifies the user segments and additional attributes in the meta data to match the best possible ad for a provider for that user. For example, if a male, baby boomer is watching a Sunday afternoon NFL game and previously was Internet browsing for a running shoe, then a running show ad is selected for the provider ad server 17 based on the matching service provided by processing server 25.

### Targeting a Household

The browsing data received by one or many individuals all using the same external IP with varying local IPs will be collected and analyzed into profile segments. These segments collectively create a household that can be targeted. The delivery of an ad based on previous browsing history and interests is reliant on the most recent data set. For example, if two individuals are behind the same external IP and their devices can be identified via local IP, device id, and/or user agent information, then then can be grouped into a household that can be targeted.

### Targeting an Individual

Alternatively, existing acoustic recognition techniques such as audio fingerprinting can be used to identify the television content using a user's device to listen and match content being watched in the same room or listening area. For example, two individuals could be in different rooms from each other. For example, assume one of the individuals, a user with a local IP of 192.168.123, is browsing for shopping items. The television is audible and the user device would be able to recognize this audio and match the user with the television program. From here, if a relevant offer is ready to air for that user after the data aggregator and targeting processing 27 provides the user match, the provider ad server 17 then delivers a relevant offer to that the TV. The user device (set top box, smart tv, etc. . . . ) would be able to match the external IP and local IP of the device to provide the correct ad from the provider ad server 17.

### Data Distribution to Providers Ad Server:

Once processing server 25 has identified and validated a promotion in data aggregator and targeting processing 27, processing server 25 sends the captured user data to the provider ad server 17. From here, the provider ad server 17 will need to receive data at the user's profile to know who this data set is related to, what their interests are, and what valid promotions can be sent to the user. If all this is validated, then the shared promotion will be delivered by the content scheduler/distributer 19.

### Content Distribution to Viewer:

Once processing server 25 has identified the user, determined the product interests of the user, and the user's browsing history, the user can then be served an ad based on the user's unique IP/Profile data. This can happen during any commercial break during the normally televised viewing period.

### Example

There are many applications where getting contextual information and/or services to a person's TV is desirable and welcome. For the user, this is presented as a feature to enhance their TV experience by presenting them with advertising that ties in to their interests. If the user is constantly seeing advertisements that do not align with their beliefs, purchasing habits, or interests, then it does not hold value for the user which in turn does not provide the best content to display from the provider. It is in the interest of the user and provider to display content that the user would appreciate.

1. A method for delivering advertising information during a television broadcast, which delivered advertising is based on an Internet browsing history and enables replacement of preprogrammed advertising information, said method comprising:
associating a television receiving device having an IP address with a computer browsing device having a corresponding IP address or different IP address;
after said associating, creating a new user profile or updating an existing user profile corresponding to said corresponding or different IP address and an IP address based on cookie data from publisher website pages accessed by said computer browsing device via said corresponding or different IP address;
analyzing said user profile to determine products or services of interest based on said user profile to produce a consumer interest profile;
identifying existing advertising information which corresponds to at least one of said determined products or services of interest identified in said consumer interest profile;
sending said identified existing advertising information to a content scheduler and distributor which operates to replace said preprogrammed advertising information with said identified existing advertising information when provided to said television receiving device.

2. The method defined by claim 1 wherein said cookie data which includes data recorded by said publisher websites while being accessed by said computer browsing device is used by said analyzing to build said consumer interest profile from data provided by said publisher website pages accessed by said computer browsing device indicating website pages of said publisher website accessed by said computer browsing device.

3. The method defined by claim 2 wherein said publisher website pages accessed by said computer browsing device collect said cookies placed by operation of a publisher ad server based on pages of said publisher website accessed by said computer browsing device.

4. The method defined by claim 3 wherein said updating comprises pulling said user profile from a user profile database, and updating said user profile based on information provided by said ad server and said collected cookies.

5. The method defined by claim 3 wherein said creating comprises determining if a user profile corresponding to said information provided by said publisher ad server and said collected cookies exists in a user profile database, and if said user profile is missing from said user profile database, adding said user profile to said user profile database based on said collected cookies.

6. The method defined by claim 2 wherein said analyzing comprises collecting information including time and date of access, an ad_placement_id, an ad_id, a user_id, an internal client_ip, an external client_ip, and a referral_url based on information provided by said publisher websites accessed by said computer browsing device.

7. The method defined by claim 6 further comprising providing said collected information to a processing server to perform an automated review of the user profile to determine the consumer interest profile.

8. The method defined by claim 7 further comprising using said consumer interest profile and a database of ads to send to a provider ad server a recommendation of an ad from said database of ads for promotion delivery.

9. The method defined by claim 8 further comprising sending user identification data and the recommended ad to the provider ad server which sends the recommended ad to the content scheduler and distributor which sends the recommended ad to said television receiving device at a selected time to replace said preprogrammed advertising information.

10. A system for coupling to a publisher ad server and a provider ad server, wherein the publisher ad server interacts with a computer browsing device to provide ads based on publisher website pages accessed by said computer browsing device, and for coupling to a provider ad server, wherein said provider ad server delivers ads to a content scheduler and distributer which causes said delivered ads to be sent at selected times to a television receiving device having an IP address, said computer browsing device having a corresponding IP address or a different IP address, said system comprising:
a processing server which operates to create a new user profile or update an existing user profile corresponding to said corresponding or different external IP address and an IP address based on cookie data from said publisher website pages accessed by said computer browsing device via said corresponding or different IP address;
a data aggregator and targeting processor which operates to a) associate said television receiving device with said computer browsing device, b) analyze said new user profile or said updated user profile to determine products or services of interest based on said user profile to build a consumer interest profile, c) identify existing advertising information which corresponds to at least one of said determined products or services of interest based on said consumer interest profile for sending to said television receiving device.

11. The system defined by claim 10 wherein said cookie data includes data recorded by said publisher website pages while being accessed by said computer browsing device to build said consumer interest profile from data provided by said publisher website pages accessed by said computer browsing device indicating pages of said publisher website accessed by said computer browsing device.

12. The system defined by claim 11 wherein said publisher website pages accessed by said computer browsing device collect said cookies placed by operation of a publisher ad server being accessed by said publisher website based on pages of said publisher website accessed by said computer browsing device.

13. The system defined by claim 12 wherein said update of said existing user profile comprises pulling said user profile from a user profile database, and updating said existing user profile based on information provided by said publisher ad server and said collected cookies.

14. The system defined by claim 13 wherein said create a new user profile comprises determining if a user profile corresponding to said information provided by said publisher ad server and said collected cookies exists in a user profile database, and if said user profile is missing from said user profile database, adding said user profile to said user profile database based on said collected cookies.

15. The system defined by claim 12 wherein said analyze said user profile comprises collecting information including time and date of access, an ad_placement_id, an ad_id, a userid, an internal client_ip, an external client_ip, and a referral_url based on information provided by said publisher website pages accessed by said computer browsing device.

16. The system defined by claim 15 further comprising providing said collected information to a processing server to perform an automated review of the user profile to determine the consumer interest profile.

17. The system defined by claim 16 further comprising using said consumer interest profile and a database of ads to send to a provider ad server a recommendation of an ad from said database of ads for promotion delivery to said television receiver.

18. The method defined by claim 17 further comprising sending user identification data and the recommended ad to the provider ad server which sends the recommended ad to a content scheduler and distributor which sends the recommended ad to said television receiving device at a selected time.
